(19) United States
(12) Patent Application Publication
(10) Pub. No.: US 2026/0184020 A1
(43) Pub. Date: Jul. 2, 2026

(54) 3D PRINT CORRECTIONS USING CHEMICAL PRECIPITATION REACTIONS

(71) Applicant: INTERNATIONAL BUSINESS MACHINES CORPORATION, Armonk, NY (US)

(72) Inventors: Su Liu, Austin, TX (US); Sarbajit Kumar Rakshit, Kolkata (IN); Tushar Agrawal, West Fargo, ND (US); Jill S. Dhillon, Jupiter, FL (US); Vinod Anandram Valecha, Pune (IN)

(21) Appl. No.: 19/007,916

(22) Filed: Jan. 2, 2025

(51) Int. Cl. B29C 64/393; B29C 64/30; B29C 71/00; B33Y 40/20; B33Y 50/02; G05B 19/418

(52) U.S. Cl. CPC B29C 64/393; B29C 64/30; B29C 71/0009; B33Y 40/20; B33Y 50/02; G05B 19/41875; B29C 2071/0027; G05B 2219/32222; G05B 2219/32335

(57) ABSTRACT

A computer-implemented method includes identifying a defect in a three-dimensional (3D) printed object and determining a chemical precipitation reaction to repair the defect utilizing a machine learning neural network and solubility rules. Solutions are selected to be dispensed to result in the chemical precipitation reaction. The solutions are applied within the defect to cause the chemical precipitation reaction to occur within the defect in the 3D printed object.

### BACKGROUND

The present invention generally relates to three-dimensional (3D) and four-dimensional (4D) printing and, more particularly, to systems and methods that enable corrections on 3D printed objects using chemical precipitates.

Three-dimensional (3D) printing of an object provides a methodology for generating detailed objects, physical pieces, prototypes, etc. Printing operations can experience defects or abnormal structures. In many cases, repairs are needed to fix these defects, or the 3D printed object is discarded. 3D printed objects that include defects can have repairs reprinted over the defect. However, correcting a crack or other defect of the 3D printed object can be difficult since placement of a 3D printing nozzle in alignment with a micro passage can be difficult and time consuming. In many instances additional machining is needed to increase a size of the defect so that a sufficient gap is provided to perform 3D printing.

### SUMMARY

In accordance with an embodiment of the present invention, a computer-implemented method includes identifying a defect in a three-dimensional (3D) printed object and determining one or more chemical precipitation reactions to repair the defect utilizing a machine learning neural network and solubility rules. One or more solutions are selected to be dispensed to result in the one or more chemical precipitation reactions. The one or more solutions are applied within the defect to cause the one or more chemical precipitation reactions to occur within the defect in the 3D printed object.

In accordance with another embodiment of the present invention, a computer system includes a processor set, one or more computer-readable storage media and program instructions stored on the one or more computer-readable storage media to cause the processor set to perform operations. The operations include detecting a defect in a three-dimensional (3D) printed object; determining one or more chemical precipitation reactions to repair the defect utilizing a machine learning neural network and solubility rules; selecting one or more solutions to be dispensed to result in the one or more chemical precipitation reactions and applying the one or more solutions within the defect to cause the one or more chemical precipitation reactions to occur within the defect in the 3D printed object.

In accordance with another embodiment of the present invention, a computer program product includes one or more computer-readable storage media and program instructions stored on the one or more computer-readable storage media to perform operations. The operations include detecting a defect in a three-dimensional (3D) printed object; determining one or more chemical precipitation reactions to repair the defect utilizing a machine learning neural network and solubility rules; selecting one or more solutions to be dispensed to result in the one or more chemical precipitation reactions and applying the one or more solutions within the defect to cause the one or more chemical precipitation reactions to occur within the defect in the 3D printed object.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures, wherein:

FIG. 1 is a block/flow diagram showing a system for 3D print corrections using chemical precipitation reactions, in accordance with an embodiment of the present invention;

FIG. 2 is a perspective view showing a defect characterized by the system to generate a correction of the defect, in accordance with an embodiment of the present invention;

FIG. 3 is a perspective view showing the defect being repaired by injecting solutions to cause a precipitation reaction to generate the correction of the defect, in accordance with an embodiment of the present invention;

FIG. 4 is a block diagram showing a computer environment for 3D print corrections using chemical precipitation reactions, in accordance with an embodiment of the present invention;

FIG. 5 is a diagram showing a machine learning neural network that can be employed to identify defects and select solutions for 3D print corrections using chemical precipitation reactions, in accordance with an embodiment of the present invention; and

FIG. 6 is a flow diagram showing methods for 3D print corrections using chemical precipitation reactions, in accordance with an embodiment of the present invention.

### DETAILED DESCRIPTION

In accordance with embodiments of the present invention, systems and methods are described for repairing three-dimensional (3D) and four dimensional (4D) printed objects. Embodiments of the present invention employ chemical precipitates that are applied in solution to a defect site to repair a defect. The solution includes a fluid with a viscosity that can better penetrate cracks or other defects. The solution is applied and permitted to generate a chemical precipitation reaction. The precipitation reaction results in a solid forming to correct the defect. The chemical precipitation reaction can be performed to correct the defect in a rapid manner. This is especially useful when the 3D printing will take a longer time, as compared to a chemical precipitation reaction correction.

In an embodiment, a system or computer-implemented method can include identifying a defect in a 3D printed object and one or more defect properties. The defect properties can include, e.g., defect shape, defect dimensions, defect profile, etc. One or more chemical precipitation reactions can be determined to repair the defect in the 3D printed object utilizing, e.g., a machine learning model and a historical dataset of defects with one or more associated chemical precipitation reactions. One or more nozzles can be selected to dispense one or more solutions that can result in a chemical precipitation reaction. A nozzle can be guided and located relative to a defect (e.g., a crack, a void, etc.). The solution or solutions can be applied or injected into the defect to cause the chemical precipitation reaction to occur within an identified defect in the 3D printed object. Another nozzle can be employed for suction on any liquid supernate from the defect, leaving any solidified precipitate to repair the identified defect. The process can be iterative to gradually build up a repair.

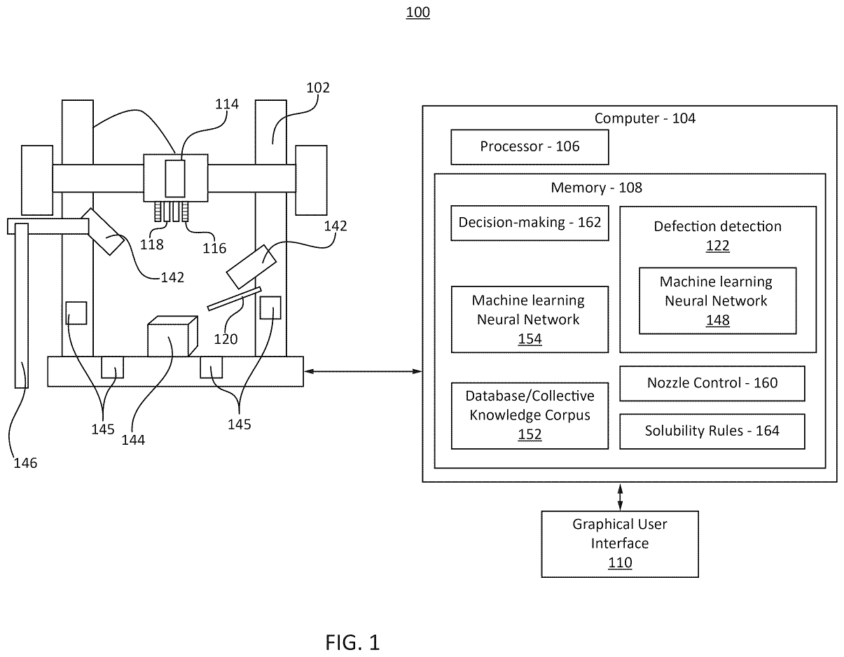

Referring now to the drawings in which like numerals represent the same or similar elements and initially to FIG. 1, a system 100 for 3D/4D printing and repair of defects using precipitates from solution is shown and described in accordance with embodiments of the present invention. A 3D printer 102 includes an additive manufacturing printer that can render a physical object (3D print object 144) with high precision in accordance with blueprints or a digital model (e.g., a computer aided design (CAD) model) of a device or object to be printed.

The system 100 can include one or more cameras 142. The cameras 142 can be connected to a computer system 104. The cameras 142 can be placed at a number of locations and angles to gather data from a plurality of perspectives. The cameras 142 can be mounted on a gantry 146 or other structure or structures that can permit adjustments to the positions of the cameras 142. The cameras 142 can include magnification capabilities, focus settings, aperture settings, etc. and lighting conditions, lighting angles, number of sources, etc., which can be set and adjusted, as needed. These camera settings and lighting settings can be adjusted to ensure proper information gathering.

The system 100 can include the computer system 104, which can include any type of computing device, such as, e.g., a desktop computer, a laptop, a cell phone or any other suitable processing device that can run software and store data. The computer system 104 includes one or more processors 106 configured to control operations of the system 100 and to run software stored in a memory 108. The memory 108 can include any form of memory including but not limited to a hard drive with solid state memory. A user interface, such as, a graphical user interface (GUI) 110 and other peripherals can also be employed for interacting with the system 100. The GUI 110 permits operator input and display capabilities. Other peripheral devices and interfaces are also contemplated.

The 3D printer 102 with multiple nozzles that can be employed for print corrections. The 3D printer 102 can include a print head 114 with one or more nozzles 116 for depositing build material and one or more solution nozzles 118 for dispensing chemical solutions. In some embodiments, the nozzles 116 for building the printed object 144 can be employed for the solution nozzles 118. The system 100 may also include a suction nozzle 120 for removing excess liquid. The 3D printer 102 can also include a 4D printer of any other additive manufacturing printer.

The computer system 104 can store software instructions in memory 108. The computer system 104 can be employed to run the 3D printer 102 and handle other operations in accordance with embodiments of the present invention.

While defect detection can be carried out manually, in an embodiment, a defect detection program 122 may be provided to analyze sensor data to identify defects in a printed object 144. The sensor data can include data from one or more sources. For example, the cameras 142 can capture image data from the printed object 144 and determine an extent or severity of a defect. The image capture data can be processed by the defect detection program 122 to compare the printed object 144 to other images to locate defects.

Defect detection program 122, stored in memory 108, can be employed for training of a machine learning neural network 148. The machine learning neural network 148 can be trained by interpreting the images with identified defects on the printed object 144 and associating the defects with correction solutions with the best outcomes. Once trained, the machine learning neural network 148 can be employed to recommend a chemical composition and parameters needed to carry out a repair of a defect.

In an embodiment, the machine learning neural network 148 can be employed to assist in defect detection. Another machine learning neural network 154 can be employed for repair planning based on historical data for the printed object 144. Historical data can be collected and stored in a database or collective knowledge corpus 152 for defects previously discovered and corrected.

In other embodiments, the defect corrections can be determined manually. In such cases, the user can query the machine learning neural network 154 directly to determine appropriate chemical precipitation reactions for repairing detected defects.

The system 100 may include various sensors for collecting data about the 3D printed objects and any defects. Cameras 142 may be used to capture visual image data of the printed object 144 from multiple angles. The cameras 142 may include high-resolution digital cameras capable of capturing detailed surface images and macro photography for close-up inspection. The system 100 can also incorporate other sensors 145, such as, e.g., ultrasound transducers for non-destructive inspection of the internal structure of printed objects. The ultrasound transducers may emit high-frequency sound waves that penetrate the object and analyze the reflected waves to detect internal defects or voids. Additional inspection systems may also be included, such as laser scanners, structured light scanners, etc. These systems may provide detailed 3D scans and cross-sectional views of the printed objects to identify both surface and internal defects. In some cases, thermal imaging cameras may be used to detect temperature variations that could indicate structural issues.

The sensor data from the cameras 142, the sensors 145, and other inspection systems may be collected and analyzed by the defect detection program 122. The defect detection program 122 can employ image processing, signal analysis, and machine learning techniques to automatically identify and characterize defects in the printed objects based on the multi-modal sensor data. The camera 142, the sensors 145, etc. allow for thorough inspection and precise defect localization to guide the chemical precipitation-based repair process.

In an embodiment, a repair process for a discovered defect on a printed object can include defect detection and characterization. The system 100 can utilize the sensors 145 (e.g., ultrasound transducers, etc.), cameras 142 and other inspection systems to identify and analyze defects in the printed object 144. The defect detection program 122 can process this multi-modal sensor data to determine the location, size, shape, and nature of the defect. In another embodiment, the defect is evaluated manually.

Once the defects are discovered and evaluated, a repair strategy is determined. Based on the defect characteristics, the machine learning neural network 154 is inferenced to determine the most appropriate chemical precipitation reaction for repairing the defect. This decision may be informed by the machine learning neural network 154 trained on historical data of successful repairs. The system 100 can select and prepare the appropriate chemical solutions. The composition and concentration of these solutions may be tailored to the specific defect and desired precipitate properties or include solutions or combination of solutions already stocked.

The computer system 104 can include software for nozzle control 160 to guide the positioning of the solution nozzles 118 relative to the detected defect as precise alignment may be needed for an effective repair, especially for small or intricate defects. Prepared chemical solutions may be dispensed into the defect site using the solution nozzles 118. A flow rate and volume of solution applied may be carefully controlled to ensure optimal coverage and reaction conditions. The applied solutions may be allowed to react, forming a solid precipitate within the defect. Environmental controls may be employed to adjust temperature, humidity, or other factors to optimize the precipitation process.

The suction nozzle 120 may be employed to remove any excess liquid (supernate) from the defect site, leaving behind the solidified precipitate to form the repair. The repaired area may be re-inspected using the sensors 145 and cameras 142 to verify the quality and completeness of the repair. If necessary, the process may be repeated iteratively, gradually building up the repair until the defect is fully corrected. In some cases, additional post-processing steps such as curing, polishing, or surface treatment may be applied to ensure the repaired area integrates seamlessly with the rest of the printed object 144. This repair process may allow for rapid and precise correction of defects in 3D printed objects, potentially offering advantages in speed and accuracy over traditional reprinting or manual repair methods.

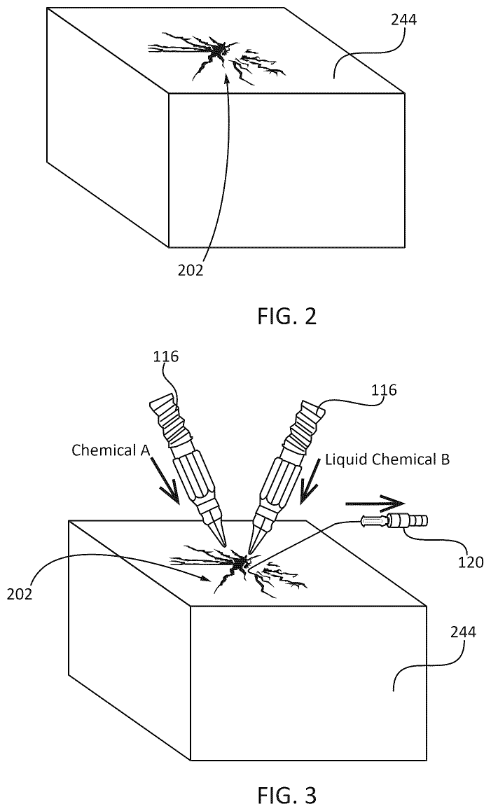

Referring to FIG. 2, a printed object 244 includes a defect 202. The defect 202 may be difficult to reach using a 3D printing nozzle. To correct the defect 202, a liquid chemical can more easily penetrate the crack. Based on the types of defects 202 to be corrected, solubility rules, historical data corpus, etc., configurations of the printed object 244 can be employed to perform a comparative analysis between chemical precipitation reactions and 3D printing based correction, and accordingly, determine whether a chemical precipitation reaction can be selected to correct the defect 202. The system 100 can be employed to control appropriate types of liquid chemicals that will be mixed to fix the defect 202 on the printed object 244 using a chemical precipitation reaction at the defect 202 so that the defect 202 can be corrected.

Referring to FIG. 3 with continued reference to FIG. 1, based on the size or dimension of the defect 202 that is to be corrected with a chemical precipitation reaction, the system 100 can dynamically control flow rates of the liquid chemicals dispensed at a target location on the printed object 244 through solution dispensing nozzles 116, so that with chemical precipitation reaction solid substance can be produced to correct the defect 202. The nozzles 116 can include different chemicals (e.g., chemical A and liquid chemical B) that can react to form a precipitate to correct the defect 202.

The system 100 through nozzle control 160 can control a volume and movement of the nozzles 116 based on a profile of the defective area, e.g., dimension of a crack, spread of the defective area, etc., so that the entire target area can be corrected with the chemical precipitation reaction. Precipitation reactions occur when cations and anions in aqueous solution combine to form an insoluble ionic solid called a precipitate. Whether or not such a reaction occurs can be determined by using solubility rules for common ionic solids. Because not all aqueous reactions form precipitates, the solubility rules can be consulted before determining the state of the products. The ability to predict these reactions permits a determination of which ions are present in a solution and allows the formation of chemicals by extracting components from these reactions.

Precipitates are insoluble ionic solid products of a reaction, formed when certain cations and anions combine in an aqueous solution. The determining factors of the formation of a precipitate can vary. Some reactions depend on temperature, such as solutions used for buffers, whereas others are dependent only on solution concentration. The solids produced in precipitate reactions are crystalline solids and can be suspended throughout the liquid or fall to the bottom of the solution. The remaining fluid is called supernatant liquid. The two components of the mixture (precipitate and supernate) can be separated using, e.g., gravity.

In an example, a chemical reaction between potassium chloride (KCl) and silver nitrate (AgNO₃), in which solid silver chloride is precipitated out of the solution, is described. The precipitate is an insoluble salt formed as a product of the precipitation reaction. The chemical equation is given by AgNO₃(aqueous)+KCl(aqueous)→AgCl(precipitate)+KNO₃(aqueous).

In this reaction, silver chloride, which is a white color solid-state precipitate, is formed, which is insoluble in nature. This solid silver chloride is precipitated out because of its insolubility in water. While silver chloride is given as a precipitate, any solid precipitate can be employed to fill in the defect 202 on the printed object 144. The chemical precipitation reaction can include a combination of two or more types of chemicals.

In accordance with embodiments of the present invention, iron can be precipitated from a solution. A first chemical will react with the iron ions in solution to form an insoluble iron compound, e.g., by adjusting the pH to a level where iron hydroxide precipitates out as a solid. This can include adding a base like sodium hydroxide (NaOH) to the solution, causing the iron ions to react with hydroxide ions and form a solid precipitate like iron(II) hydroxide (Fe(OH)₂) or iron(III) hydroxide (Fe(OH)₃) depending on the oxidation state of the iron in the solution. The reactions can include, e.g., Fe(II) (aq)+2OH-(aq)→Fe(OH)2 (s) or Fe(III) (aq)+3OH-(aq)→Fe(OH) 3 (s). In other embodiments, copper can be precipitated from a solution by adding hydroxide ions (like sodium hydroxide, NaOH) to a copper solution, which will cause copper hydroxide (Cu(OH)₂) to precipitate out. Adding a sulfide source (like sodium sulfide, Na₂S) to a copper solution can also precipitate copper sulfide (CuS). In other embodiments, to precipitate a polymer from a solution, a first polymer can be dissolved in a good solvent, then, a poor solvent (miscible with the good solvent) can be added which will cause the polymer molecules to lose their solubility and precipitate out as solid particles in a “solvent precipitation” process controlled by adjusting the addition rate of the poor solvent and temperature. For example, polyurethane or other polymer in a solvent solution can be precipitated from the solvent solution by adding a non-solvent to the polyurethane solution, This will disrupt the solubility of the polyurethane, causing it to separate out as a solid phase by adding a poor solvent, like water, while maintaining proper mixing conditions to ensure a uniform precipitation process. The precipitates can be further processed, e.g., heating, adding chemical solutions, etc. to achieve a final result. The precipitated products can also be further processed chemically, mechanically or otherwise to produce a final repair.

The suction nozzle 120 can be employed to remove liquid supernate during or after the reaction to allow the precipitate to get solidified at the target location. The system 100 analyzes and tracks the completion of the chemical precipitation reaction at the target location, and identifies when action is to be performed with suction nozzle 120, so that supernate is removed, and subsequent liquid chemicals can be applied to produce precipitate at the correct location.

Different types of liquid chemicals can produce different types of precipitates with the chemical precipitation reaction, and the different precipitates can also have different properties. The system 100 analyzes the properties of the printed object 144, usage, material properties, etc., and selects one or more combinations of chemical precipitation reactions to generate different types of precipitate at different layers of a desired correction.

The 3D defect correction can be made by comparing chemical precipitation reactions with 3D printing, using solubility rules and historical data. The reaction is dynamically controlled with liquid chemical flow to adjust nozzle volume and movement based on defect profiles. The system 100 tracks reaction completion and supports multi-layer correction with varied precipitates tailored to the printed object 144 properties.

Depending on the outcome of the comparison, the system 100 can orchestrate defect fixing by chemical selection for the chemical reaction. The system 100 can identify combinations of chemicals based on the properties of the printed object 144 substrate and the defect that needs to be fixed. The amount of chemicals, speed and sequence in which the chemicals are mixed is also controlled. The system 100 will also analyze the profile of the defective area and control the volume and movement of the liquid chemical nozzles 116. The system 100 tracks the chemical reaction(s) and their sequence at the target location and deploys nozzles 120 to complete the process or extract the liquid supernate to allow precipitate to get solidified for defect fixing.

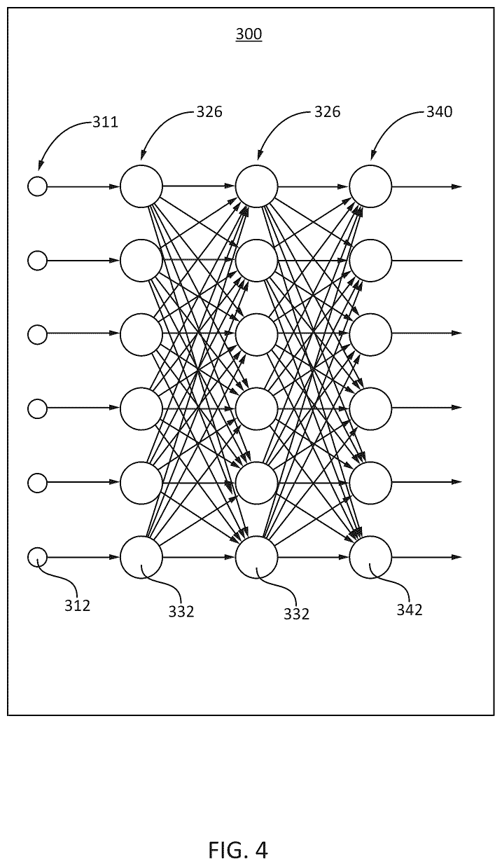

Referring to FIG. 4 with continued reference to FIG. 1, a machine learning neural network 300 is shown and described. The system 100 may employ a specialized neural network architecture to handle defects and select appropriate chemicals and parameters for dispensing the chemicals to form the precipitate. The machine learning neural networks 148 and 154 while described separately can be combined into a single machine learning neural network 300. This neural network 300 may be designed to process multiple inputs related to the defect characteristics, material properties, and chemical reaction parameters. The neural network 300 may include an input layer 311 with input nodes 312 that receive data such as defect type, size, location, material composition of the 3D printed object, and available chemical options. This input data may be preprocessed and normalized before being fed into the network.

Multiple hidden layers in the network 300 may process this information through various neurons 332 with non-linear activation functions. These layers 326 may extract relevant features and learn complex relationships between the input parameters and optimal chemical precipitation reactions.

An output layer 340 of the neural network 300 may provide recommendations for selection of appropriate chemical reagents, concentration of each reagent, flow rates for dispensing each chemical, nozzle movement patterns, timing of chemical application and suction cycles. In some embodiments, the neural network 300 can utilize recurrent connections to process sequential data related to the chemical reaction progress over time. This may allow the network 300 to dynamically adjust parameters as the precipitation reaction occurs.

The network 300 may be trained on a large dataset of historical defect repairs, including successful and unsuccessful attempts. During training, the network 300 may learn to optimize for factors such as repair quality, material compatibility, and efficiency of the chemical precipitation process. The neural network 300 may work in conjunction with other machine learning models, such as reinforcement learning agents, to continuously improve its performance based on feedback from actual repair outcomes. This may allow the system 100 to adapt to new types of defects or materials over time. The neural network 300 can include outputs that are used to control the various nozzles and actuators in the system, allowing for precise and automated application of chemicals to form the precipitate and repair the defect. The network 300 may also provide real-time adjustments based on sensor feedback during the repair process.

The neural network 300 can assist in analysis of the printed object 144 to determine the type of defect that needs to be corrected. This analysis can include the size, dimension, and profile of the defective area. The neural network 300 can include, e.g., a Convolutional Neural Network (CNN) to perform the analysis. A dataset of 3D printed objects, where each object has a specific defect or defects can be created. This dataset should be large enough to cover all types of defects, sizes, dimensions, and profiles. Once the dataset is created, the dataset is preprocessed to convert 3D objects into a 2D image format, which can be done by slicing the 3D objects into 2D images at different angles. These images can be used as input to the neural network 300. The CNN architecture of the neural network 300 can be constructed. The CNN model of the neural network 300 includes several layers 326, such as convolutional layers, pooling layers, and fully connected layers. The number of layers 326 and their configurations will depend on the complexity of the dataset.

After the CNN architecture is designed, the training process involves feeding the preprocessed data to the CNN model of the neural network 300 and adjusting the weights of the model to minimize the error between the predicted output and the actual output. This is done by using a training dataset and an optimization algorithm such as, e.g., Stochastic Gradient Descent (SGD). Other optimization algorithms can also be employed. After the model is trained, the model can be tested on a new dataset. This dataset should be different from the training dataset and should have a similar distribution of defects. The output of the model will be the predicted defect type, size, dimension, and profile.

In a simpler version of the neural network 300 for a dataset of 3D printed objects with two types of defects, e.g., cracks and voids, each object is represented as a set of 2D images, which are obtained by slicing the object at different angles. The dataset can be split into training and testing datasets. The data can be preprocessed by converting the 3D objects into 2D images. The data can be normalized by assigning pixel values between 0 (defect) and 1 (no defect) to make it easier for the CNN model to learn. A CNN model architecture, in this example, can include hidden layers 326. While FIG. 4 depicts only two hidden layers 326, in an embodiment, the hidden layers 326 can include, e.g., two convolutional layers, followed by two pooling layers, and then two fully connected layers. An output layer 340 can have any number of nodes 342. In the example, only the output layer 340 has two nodes representing the two types of defects (“cracks” and “voids”). Other defects are contemplated as well.

The CNN model can be trained on the training dataset using the SGD optimization algorithm with a batch size of, e.g., 32 and 10 epochs. A loss function used can include categorical cross-entropy, and the optimizer used, can be e.g., Adam™.

The performance of the CNN model can be evaluated on the testing dataset. The CNN model predicts the type of defect, size, dimension, and profile. The accuracy, precision, recall, and F1 score can be computed to measure the performance of the CNN model.

By using CNNs, 3D printed objects are efficiently analyzed and defects identified, which can help in correcting the defects and improving the quality of the object. Based on the analysis of the printed object 144, the system 100 can perform a comparative analysis between chemical precipitation reactions and 3D printing-based correction to determine the best approach to correct the defect. To achieve this, a decision-making algorithm 162 can be employed that considers the results of the analysis of the 3D printed object and performs a comparative analysis between chemical precipitation reactions and 3D printing-based correction. The decision-making algorithm 162 can use machine learning employing, e.g., the machine learning neural network 154. Instead or in addition to the machine learning neural network 154, the decision-making algorithm 162 can include decision trees, support vector machines, or random forests to compare the two approaches and determine which one is the best suited for correcting the defect.

The decision-making algorithm 162 can consider several factors such as the size and shape of the defect, the material used for printing, the complexity of the correction, and the time and cost required for each approach. For example, if the defect is small and the correction is simple, a chemical precipitation reaction might be more effective and cost-efficient. However, if the defect is complex and requires a high degree of precision, 3D printing-based correction might be the better option.

The decision-making algorithm 162 can take as input the results of the analysis of the 3D printed object, including the size, dimension, and profile of the defective area. The decision-making algorithm 162 extracts relevant features from the input, such as the size, shape of the defect, material used for printing, and complexity of the correction. The decision-making algorithm 162 performs a comparative analysis between chemical precipitation reactions and 3D printing-based correction using machine learning techniques such as decision trees or support vector machines. The decision-making algorithm 162 outputs the best approach for correcting the defect based on the results of the comparative analysis. For example, the output can indicate that 3D printing-based correction is the best option due to its precision and accuracy, despite its higher cost and longer processing time.

If the comparative analysis determines that chemical precipitation reaction is the best approach, the system 100 will select appropriate types of liquid chemicals based on historical data corpus and solubility rules and will mix them at a target location on the printed object 144 using the printer 102 or other system (e.g., a robotic system).

Depending on the size and dimension of the defect, the system 100 dynamically controls the flow rate of the liquid chemicals at the target location on the 3D object, so that a solid substance can be produced with a chemical precipitation reaction(s) to correct the defect. Based on the profile of the defective area, e.g., dimensions of a crack, spread of the defective area, etc., the system 100 controls the dispensing volume and movement of the liquid chemical nozzle, so that the entire target area can be corrected with the chemical precipitation reaction(s). Suction of the liquid supernate can be monitored by the system 100 through the completion of the chemical precipitation reaction at the target location and will identify when action is to be performed so that the supernate is removed, and subsequent liquid chemicals can be applied to produce precipitate at the correct location.

Different types of liquid chemicals can produce different types of precipitates with chemical precipitation reaction, and the different precipitates can also have different properties. The system 100 can analyze the properties of the 3D object, usage, and substrate behavior etc., and accordingly select one or more combinations of chemical precipitation reactions to generate different types of precipitate at different layers of the desired correction.

Based on the analysis of the printed object 144 and comparative analysis between chemical precipitation reaction and 3D printing-based correction, the system 100 can select the appropriate approach to correct the defect. If a chemical precipitation reaction is selected as the approach, the system 100 can control an appropriate number of nozzles 116 to apply liquid chemicals to generate precipitate, and the nozzle 120 can be used to perform suction on the generated supernate to generate precipitate to correct the defect.

The machine learning neural networks 148, 154 include a system that improves its functioning and accuracy through exposure to additional empirical data. The neural networks become trained by exposure to the empirical data. During training, the neural networks store and adjust a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Examples can include solid-state batteries having particular failure modes being associated with countermeasures, shock and vibration response features associated with countermeasures, etc. Each example can be represented as a pair, (x, y), where x represents the input data and y represents the known output. The input data may include a variety of different data types and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the neural network(s) can be used on new data that was not previously used in training or validation through generalization. The adjusted weights of the neural network(s) can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer of source nodes, and a single computation layer having one or more computation nodes that also act as output nodes, where there is a single computation node for each possible category into which the input example could be classified. An input layer can have a number of source nodes equal to the number of data values in the input data. The data values in the input data can be represented as a column vector. Each computation node in the computation layer generates a linear combination of weighted values from the input data fed into nodes of the input layer and applies a non-linear activation function that is differentiable to the sum. The exemplary simple neural network can perform classification on linearly separable examples (e.g., patterns).

A deep neural network, such as a multilayer perceptron, can have an input layer of source nodes, one or more computation layer(s) having one or more computation nodes, and an output layer, where there is a single output node for each possible category into which the input example could be classified. An input layer can have a number of source nodes equal to the number of data values in the input data. The computation nodes in the computation layer(s) can also be referred to as hidden layers, because they are between the source nodes and output node(s) and are not directly observed. Each node in a computation layer generates a linear combination of weighted values from the values output from the nodes in a previous layer and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

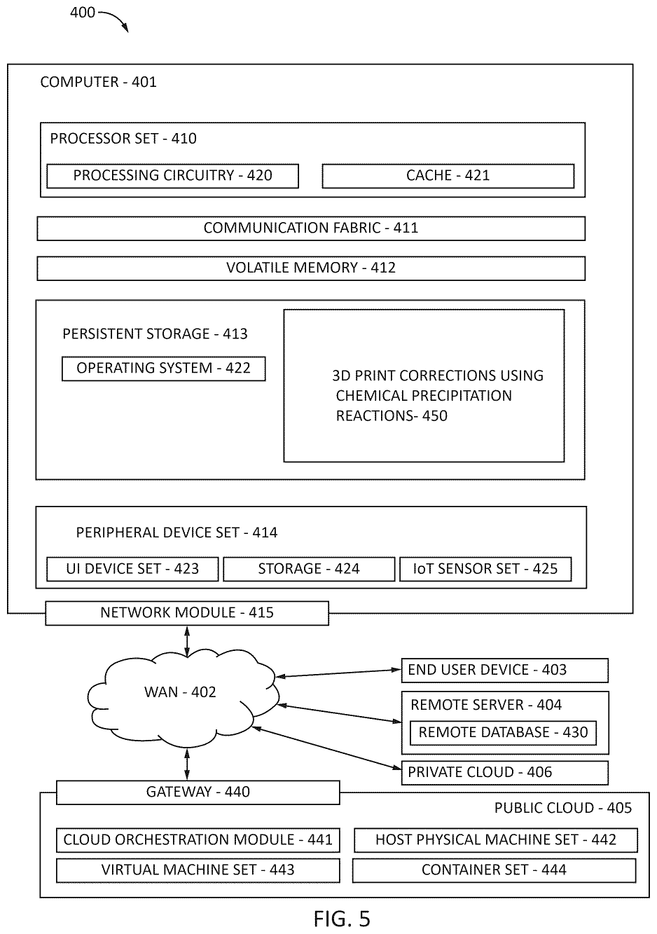

Referring to FIG. 5, a computing environment 400 includes an example of an environment for the execution of at least some of the computer code involved in performing the inventive methods 450, such as, systems and methods for 3D print corrections using chemical precipitation reactions. In addition to block 450, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 450, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 5. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 450 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid-state storage devices. Operating system 422 may take several forms, such as various known proprietary operating systems or open-source Portable Operating System Interface-type operating systems that employ a kernel. The code included in block 450 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415. WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

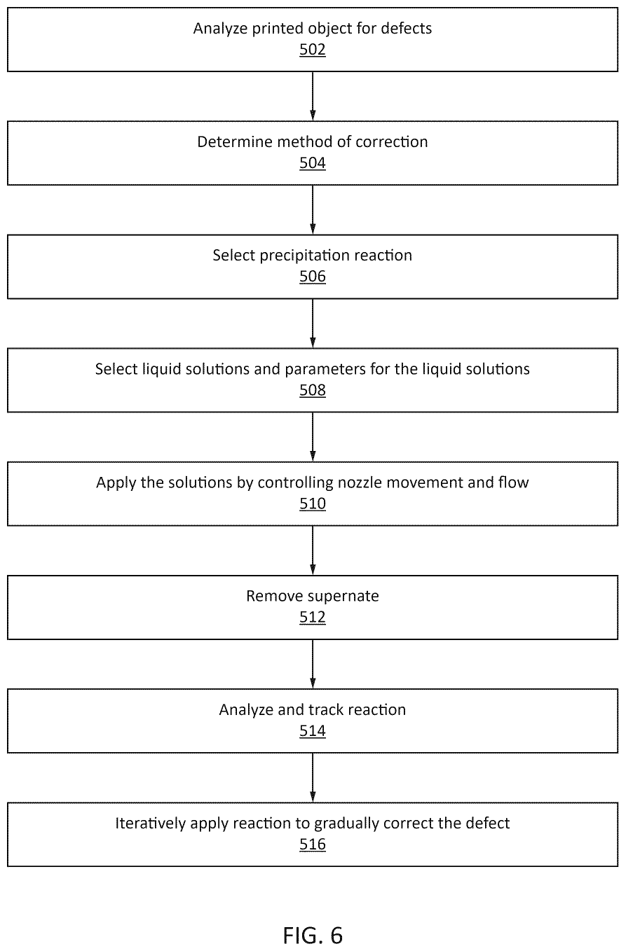

Referring to FIG. 6, a system and computer-implemented method for 3D print corrections using chemical precipitation reactions is shown, in accordance with embodiments of the present invention. In block 502, a 3D printed object can be analyzed for defects. This can include identifying a defect or defects in the printed object using cameras, sensors, manual inspections, etc. The defect can be identified and characterized using, e.g., a machine learning neural network.

In block 504, a determination can be made as to whether a 3D printing solution should be employed or a chemical precipitation reaction should be used. The decision-making algorithm can be employed to decide the method of repair for the defect. The determination can consider chemical precipitation reactions using a historical dataset of defects with associated chemical precipitation reactions.

In block 506, if the determination results in the chemical precipitation reaction method, one or more chemical precipitation reactions can be determined to repair the defect. This can include analyzing solubility rules to predict the formation of precipitates based on combinations of ions present in the one or more solutions and selecting chemical reactions that produce precipitates with properties suitable for repairing the identified defect in the 3D printed object.

In an embodiment, a machine learning neural network can be employed to select the reaction. The reaction can be selected based upon the type of defect, e.g., by identifying one or more defect properties of the defect in the 3D printed object, which can include at least one of defect shape, defect dimensions and defect profile. Solubility rules and an analysis of the printed objects'properties can be employed in determining the type of reaction needed.

In block 508, the machine learning neural network can also select the liquid solutions to be dispensed to result in the one or more chemical precipitation reactions. For example, molarities, normalities, compositions of solutions, etc. can be determined. Other parameters of the solutions needed for the reactions can be determined as well as the reaction conditions (e.g., temperature, etc.), the nozzle types, flow rates, etc.

In block 510, the one or more solutions are applied within the defect to cause the one or more chemical precipitation reactions to occur within the defect in the 3D printed object. This includes controlling one or more nozzles to dispense the one or more solutions at a location relative to the defect. This also includes controlling a flow rate of the solutions and movements of the nozzles applying the solutions. The flow rate and the movement can be controlled based upon the defect characteristics, e.g., size, locations, etc.

In block 512, a suction nozzle can be employed to remove supernate at the target location. This can include tracking the amount of supernate and the amount of suction to promote the precipitate reaction.

In block 514, the reaction is analyzed and tracked to ensure proper correction of the defect at the target location. In block 516, the precipitate or precipitates can be iteratively applied to gradually correct the defect. Iteratively applying additional solutions and removing additional liquid supernate can be performed to gradually build up a repair within the defect.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor—or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method, comprising:
identifying a defect in a three-dimensional (3D) printed object;
determining one or more chemical precipitation reactions to repair the defect utilizing a machine learning neural network and solubility rules;
selecting one or more solutions to be dispensed to result in the one or more chemical precipitation reactions; and
applying the one or more solutions within the defect to cause the one or more chemical precipitation reactions to occur within the defect in the 3D printed object.

2. The computer-implemented method of claim 1, wherein determining the one or more chemical precipitation reactions includes:
analyzing solubility rules to predict formation of precipitates based on combinations of ions present in the one or more solutions; and
selecting chemical reactions that produce precipitates with properties suitable for repairing the defect in the 3D printed object.

3. The computer-implemented method of claim 1, further comprising identifying one or more defect properties of the defect in the 3D printed object, wherein the one or more defect properties include at least one of: defect shape, defect dimensions and defect profile.

4. The computer-implemented method of claim 1, wherein determining the one or more chemical precipitation reactions utilizes a historical dataset of defects with associated chemical precipitation reactions.

5. The computer-implemented method of claim 1, further comprising:
controlling one or more nozzles to dispense the one or more solutions at a location relative to the defect.

6. The computer-implemented method of claim 1, further comprising:
removing liquid supernate from the defect using a suction nozzle.

7. The computer-implemented method of claim 6, further comprising:
iteratively applying additional solutions and removing additional liquid supernate to gradually build up a repair within the defect.

8. A computer system, comprising:
a processor set;
one or more computer-readable storage media; and
program instructions stored on the one or more computer-readable storage media to cause the processor set to perform operations comprising:
detecting a defect in a three-dimensional (3D) printed object;
determining one or more chemical precipitation reactions to repair the defect utilizing a machine learning neural network and solubility rules;
selecting one or more solutions to be dispensed to result in the one or more chemical precipitation reactions; and
applying the one or more solutions within the defect to cause the one or more chemical precipitation reactions to occur within the defect in the 3D printed object.

9. The computer system of claim 8, wherein determining the one or more chemical precipitation reactions includes:
analyzing solubility rules to predict formation of precipitates based on combinations of ions present in the one or more solutions; and
selecting chemical reactions that produce precipitates with properties suitable for repairing the defect in the 3D printed object.

10. The computer system of claim 8, further comprising identifying one or more defect properties of the defect in the 3D printed object, wherein the one or more defect properties include at least one of: defect shape, defect dimensions and defect profile.

11. The computer system of claim 8, wherein determining the one or more chemical precipitation reactions utilizes a historical dataset of defects with associated chemical precipitation reactions.

12. The computer system of claim 8, further comprising:
controlling one or more nozzles to dispense the one or more solutions at a location relative to the defect.

13. The computer system of claim 8, further comprising:
removing liquid supernate from the defect using a suction nozzle.

14. The computer system of claim 13, further comprising:
iteratively applying additional solutions and removing additional liquid supernate to gradually build up a repair within the defect.

15. A computer program product, comprising:
one or more computer-readable storage media; and
program instructions stored on the one or more computer-readable storage media to perform operations comprising:
detecting a defect in a three-dimensional (3D) printed object;
determining one or more chemical precipitation reactions to repair the defect utilizing a machine learning neural network and solubility rules;
selecting one or more solutions to be dispensed to result in the one or more chemical precipitation reactions; and
applying the one or more solutions within the defect to cause the one or more chemical precipitation reactions to occur within the defect in the 3D printed object.

16. The computer program product of claim 15, wherein determining the one or more chemical precipitation reactions includes:
analyzing solubility rules to predict formation of precipitates based on combinations of ions present in the one or more solutions; and
selecting chemical reactions that produce precipitates with properties suitable for repairing the defect in the 3D printed object.

17. The computer program product of claim 15, further comprising identifying one or more defect properties of the defect in the 3D printed object, wherein the one or more defect properties include at least one of: defect shape, defect dimensions and defect profile.

18. The computer program product of claim 15, wherein determining the one or more chemical precipitation reactions utilizes a historical dataset of defects with associated chemical precipitation reactions.

19. The computer program product of claim 15, further comprising:
controlling one or more nozzles to dispense the one or more solutions at a location relative to the defect.

20. The computer program product of claim 15, further comprising:
iteratively applying additional solutions and removing liquid supernate to gradually build up a repair within the defect.
